(19) United States
(12) Patent Application Publication
(10) Pub. No.: US 2014/0321336 A1
(43) Pub. Date: Oct. 30, 2014

(54) Method and Apparatus for Access Point Communications

(71) Applicants: Wei Hong, Beijing (CN); Haiming Wang, Beijing (CN); Chunyan Gao, Beijing (CN); Jing Han, Beijing (CN)

(72) Inventors: Wei Hong, Beijing (CN); Haiming Wang, Beijing (CN); Chunyan Gao, Beijing (CN); Jing Han, Beijing (CN)

(21) Appl. No.: 14/359,633

(22) PCT Filed: Nov. 23, 2011
(86) PCT No.: PCT/CN2011/082701

§ 371 Date: May 21, 2014

(51) Int. Cl. H04L 5/00; H04L 5/14; H04W 36/00; H04J 3/14

(52) U.S. Cl. CPC H04L 5/0073; H04L 5/0032; H04J 3/14; H04L 5/14; H04W 36/0055
USPC 370/278; 370/329; 370/336; 370/331

(57) ABSTRACT

A method, apparatus and computer program product are provided according to some example embodiments to enable the exchange of inter cell messages among neighboring access points. In this regard, a method is provided that includes receiving a request for transmission of an inter cell (IC) message that is to be transmitted to a neighboring access point. The request for transmission further comprises scheduling information from the access point. The method further includes receiving an indication of scheduling priority from the neighboring access point. The method further includes receiving an uplink (UL) grant for the neighboring access point in response to a scheduling request (SR) transmitted to the neighboring access point. The method further includes causing the IC message to be (SR) transmitted to the neighboring transmitted to the neighboring access point.

### TECHNOLOGICAL FIELD

Embodiments of the present invention relate generally to communications technology and, more particularly, to performing over the air (OTAC) communications between access points.

### BACKGROUND

An interface, such as an X2 interface, generally supports the exchange of signaling information between two or more access points in a wireless network. The X2 interface is configured to provide, for example, interference coordination, context transfer, handover cancellation and/or the like between access points. For example, the X2 interface between neighboring access points may exchange appropriate information to allow the neighboring access points to make radio resource assignments that mitigate interference. However in some instances, the X2 interface is not available in instances of uncoordinated deployment of low power access points (e.g. home access points or pico cell access points) in local area environments. For example, interference may be experienced by an access point base on sudden changes, such as for example the power up of a home access point. Therefore to allow for the distribution of home access points and other low power access points, some communication and information exchange may be necessary for effective operations.

### BRIEF SUMMARY

A method, apparatus and computer program product are therefore provided according to some example embodiments of the current invention in order to enable the exchange of inter cell (IC) messages among neighboring access points. In some example embodiments, a fixed mobile terminal may be used to facilitate the exchange of IC messages and may be configured to attach to multiple neighboring access points. The fixed mobile terminal may further be configured to receive an IC message from a first access point and then may transmit a scheduling request to one or more neighboring access points. Once scheduled, the fixed mobile terminal then may transmit the IC message to the one or more access points. Such use of a fixed mobile terminal enables communications between the neighboring access points, for example, without interference and without significant communications delays.

In one embodiment, a method is provided that comprises receiving a request for transmission from an access point of an IC message to be transmitted to a neighboring access point. In some example embodiments the request for transmission further comprises scheduling information from the access point. The method of this embodiment may also include receiving an indication of scheduling priority from the neighboring access point, The method of this embodiment may also include receiving an uplink (UL) grant for the neighboring access point in response to a scheduling request (SR) to be transmitted to neighboring access point. The method of this embodiment may also include causing the IC message to be transmitted to the neighboring access point.

In another embodiment, an apparatus is provided that includes at least one processor and at least one memory including computer program code with the at least one memory and the computer program code being configured, with the at least one processor, to cause the apparatus to at least receive a request for transmission from an access point of an IC message to be transmitted to a neighboring access point. In some example embodiments the request for transmission further comprises scheduling information from the access point. The at least one memory and computer program code may also be configured to, with the at least one processor, cause the apparatus to receive an indication of scheduling priority from the neighboring access point. The at least one memory and computer program code may also be configured to, with the at least one processor, cause the apparatus to receive a UL grant for the neighboring access point in response to an SR to be transmitted to neighboring access point. The at least one memory and computer program code may also be configured to, with the at least one processor, cause the apparatus to cause the IC message to be transmitted to the neighboring access point.

In the further embodiment, a computer program product may be provided that includes at least one non-transitory computer-readable storage medium having computer-readable program instruction stored therein with the computer-readable program instructions including program instructions configured to receive a request for transmission from an access point of an IC message to be transmitted to a neighboring access point. In some example embodiments, the request for transmission further comprises scheduling information from the access point. The computer-readable program instructions may also include program instructions configured to receive an indication of scheduling priority from the neighboring access point. The computer-readable program instructions may also include program instructions configured to receive a UL grant for the neighboring access point in response to an SR to be transmitted to neighboring access point. The computer-readable program instructions may also include program instructions configured to cause the IC message to be transmitted to the neighboring access point.

In yet another embodiment, an apparatus is provided that includes means for receiving a request for transmission from an access point of an IC message to be transmitted to a neighboring access point. In some example embodiments, the request for transmission further comprises scheduling information from the access point. The apparatus of this embodiment may also include means for receiving an indication of scheduling priority from the neighboring access point. The apparatus of this embodiment may also include means for receiving a UL grant for the neighboring access point in response to an SR to be transmitted to neighboring access point. The apparatus of this embodiment may also include means for causing the IC message to be transmitted to the neighboring access point.

In one embodiment, a method is provided that comprises determining whether to exchange an IC message with a neighboring cell. The method of this embodiment may also include causing a request for transmission of the IC message to be transmitted to a fixed mobile terminal. In some example embodiments, the request for transmission comprises scheduling information for the fixed mobile terminal. The method of this embodiment may also include receiving an indication from the fixed mobile terminal. In some example embodiments, the indication provides a confirmation that the IC message was transmitted to the another access point in an instance in which the fixed mobile terminal received a UL grant for the another access point.

In another embodiment, an apparatus is provided that includes at least one processor and at least one memory including computer program code with the at least one memory and the computer program code being configured, with the at least one processor, to cause the apparatus to at least determine whether to exchange an IC message with a neighboring cell. The at least one memory and computer program code may also be configured to, with the at least one processor, cause the apparatus to cause a request for transmission of the IC message to be transmitted to a fixed mobile terminal. In some example embodiments, the request for transmission comprises scheduling information for the fixed mobile terminal. The at least one memory and computer program code may also be configured to, with the at least one processor, cause the apparatus to receive an indication from the fixed mobile terminal. In some example embodiments, the indication provides a confirmation that the IC message was transmitted to the another access point in an instance in which the fixed mobile terminal received a UL grant for the another access point.

In the further embodiment, a computer program product may be provided that includes at least one non-transitory computer-readable storage medium having computer-readable program instruction stored therein with the computer-readable program instructions including program instructions configured to determine whether to exchange an IC message with a neighboring cell. The computer-readable program instructions may also include program instructions configured to cause a request for transmission of the IC message to be transmitted to a fixed mobile terminal. In some example embodiments, the request for transmission comprises scheduling information for the fixed mobile terminal. The computer-readable program instructions may also include program instructions configured to receive an indication from the fixed mobile terminal. In some example embodiments, the indication provides a confirmation that the IC message was transmitted to the another access point in an instance in which the fixed mobile terminal received a UL grant for the another access point.

In yet another embodiment, an apparatus is provided that includes means for determining whether to exchange an IC message with a neighboring cell. The apparatus of this embodiment may also include means for causing a request for transmission of the IC message to be transmitted to a fixed mobile terminal. In some example embodiments, the request for transmission comprises scheduling information for the fixed mobile terminal. The apparatus of this embodiment may also include means for receiving an indication from the fixed mobile terminal. In some example embodiments, the indication provides a confirmation that the IC message was transmitted to the another access point in an instance in which the fixed mobile terminal received a UL grant for the another access point.

### BRIEF DESCRIPTION OF THE DRAWINGS

Having thus described the example embodiments of the invention in general terms, reference will now be made to the accompanying drawings, which are not necessarily drawn to scale, and wherein:

FIG. 1 is a schematic representation of a system having a fixed mobile terminal and that may benefit from some example embodiments of the present invention;

FIG. 2 is a block diagram of an apparatus that may be embodied by a fixed mobile terminal in accordance with some example embodiments of the present invention;

FIG. 3 is a flow chart illustrating operations performed by an example fixed mobile terminal in accordance with some example embodiments of the present invention;

FIG. 4 is a flow chart illustrating operations performed by an example access point in accordance with some example embodiments of the present invention; and

FIG. 5 illustrates example transmission slots in accordance with some example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

A method, apparatus and computer program product of some example embodiments of the present invention are configured to enable OTAC communications between access points. In order to facilitate OTAC communications, a fixed mobile terminal may be used to attach to multiple access points in a geographical area and to maintain the exchange of information between the multiple access points.

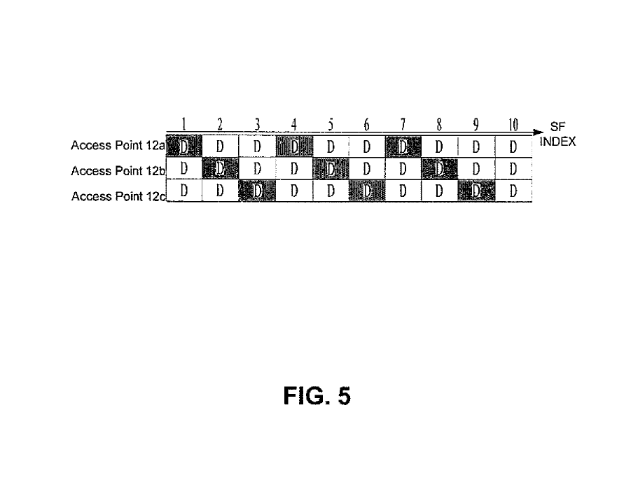

In some example embodiments, in order to avoid collision between multiple access points that schedule the example fixed mobile terminal at the same time, a rule (e.g., defined by the fixed mobile terminal, the network and/or the like) may define transmission slots for each access points to communicate with the example fixed mobile terminal. See e.g. FIG. 5. By way of example, if a first access point attempts to transmit information (e.g. IC message) to a neighbor access point, the first access point may schedule the example fixed mobile terminal in an earliest available subframe. After receiving the first access point's IC message, the example fixed mobile terminal may send an SR to one or more neighbor access points. When receiving the SR from the fixed mobile terminal, the neighbor access points may be configured to schedule the example fixed mobile terminal with a high priority so as to receive the IC message relayed from the first access point as soon as possible.

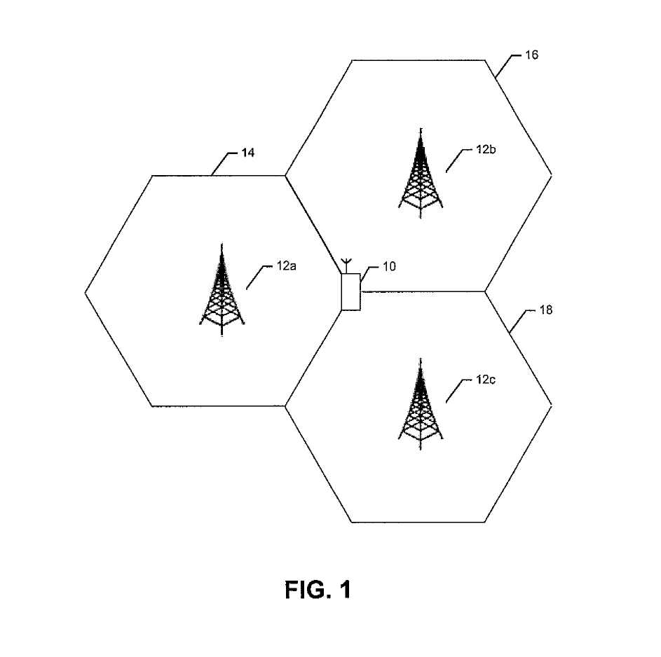

Although the method, apparatus and computer program product may be implemented in a variety of different systems, one example of such a system is shown in FIG. 1, which includes a communication device (e.g., fixed mobile terminal 10) that is capable of communication with access points 12a-c, such as a base station, a Node B, an evolved Node B (eNB), home eNB, pico eNB, serving cell or other access point. The access points 12a-c may in turn be in communication with a network (not shown). While the network may be configured in accordance with long term evolution (LTE) or LTE advanced (LTE-A), other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like. The network may include a collection of various different nodes, devices or functions that may be in communication with each other via corresponding wired and/or wireless interfaces. For example, the network may include one or more cells, including access points 12a-c, each of which may serve a respective coverage area. The serving cell and the neighbor cells could be, for example, part of one or more cellular or mobile networks or public land mobile networks (PLMNs).

A communication device, such as the fixed mobile terminal 10 (also known as user equipment (UE)), may be in communication with one or more access points 12a-c. Other communication devices, mobile terminals, other UE and/or like may also be in communications with the access points 12a-c and, in turn, the network. In some cases, the communication device may include an antenna for transmitting signals to and for receiving signals from a serving cell.

When referred to herein, a serving cell includes, but is not limited to a primary serving cell (PCell) and other serving cells such as secondary serving cells (SCell) that may be operating on an access point, such as access points 12a-c. A candidate cell, target cell, neighbor cell and/or the like may also be used herein, and that includes a cell that is not currently a serving cell, but may become a serving cell in the future. A PCell, which may be embodied by an access point, generally includes, but is not limited to, a cell that is configured to perform initial establishment procedures, security procedures, system information (SI) acquisition and change monitoring procedures on the broadcast channel (BCCH) or data channel (PDCCH), and paging. The SCell, which may be embodied by a remote radio head (RRH) and is configured to provide additional radio resources to the PCell. In an embodiment, a “primary band” is the band that is indicated by the serving cell as the band of a serving carrier frequency. The secondary band is the band that is indicated by the serving cell as an additional band (e.g. in addition to primary band), that allows a mobile terminal radio frequency that is supported by the secondary band to also camp on the cell.

In some example embodiments, the fixed mobile terminal 10 may be a mobile communication device such as, for example, a mobile telephone, portable digital assistant (PDA), pager, laptop computer, or any of numerous other hand held or portable communication devices, computation devices, content generation devices, content consumption devices, or combinations thereof. Alternatively or additionally, the fixed mobile terminal may also be embodied as a machine or other fixed medium that may be configured for use as a fixed relay. As such, the fixed mobile terminal 10 may include one or more processors that may define processing circuitry either alone or in combination with one or more memories. The processing circuitry may utilize instructions stored in the memory to cause the fixed mobile terminal 10 to operate in a particular way or execute specific functionality when the instructions are executed by the one or more processors. The fixed mobile terminal 10 may also include communication circuitry and corresponding hardware/software to enable communication with other devices.

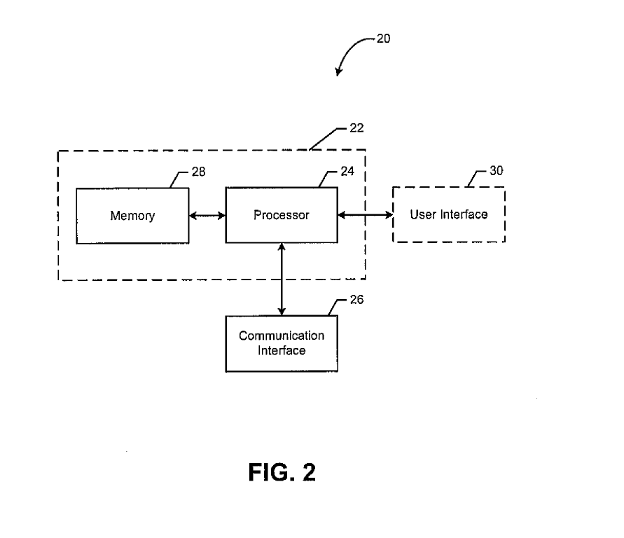

In some embodiments, for example, the fixed mobile terminal 10 and/or the access points 12a-c may be embodied as or otherwise include an apparatus 20 as generically represented by the block diagram of FIG. 2. While the apparatus 20 may be employed, for example, by a fixed mobile terminal 10 or access points 12a-c, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 28 that may be in communication with or otherwise control a communication interface 26 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments taken in the context of the fixed mobile terminal 10, the processing circuitry may be embodied as a portion of a mobile computing device or other mobile terminal.

The user interface 30 (if implemented) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. The apparatus 20 need not always include a user interface. For example, in instances in which the apparatus is embodied as access points 12a-c, the apparatus may not include a user interface. As such, the user interface is shown in dashed lines in FIG. 2.

The communication interface 26 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network and/or any other device or module in communication with the processing circuitry 22, such as between the fixed mobile terminal 10 and the access points 12a-c. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 28 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 28 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

Referring again to FIG. 1, in some example embodiments, the fixed mobile terminal 10 is configured to monitor the downlink (DL) from multiple access points within communications range, such by the processing circuitry 22, processor 24, communications interface 26, and/or like. The DL can be monitored based on time division multiplexing (TDM). TDM may be predefined by the network, access points 12a-c and/or the like and may be known to both the fixed mobile terminal 10 and the access points 12a-c within a communications range. Alternatively or additionally, in a time division duplex (TDD) network, the fixed mobile terminal 10 may configured to determine a current TDD configuration and then may further be configured to monitor those sub frames that are characterized as downlink sub frames, such by the processing circuitry 22, processor 24, communications interface 26 or like.

In further example embodiments, the example fixed mobile terminal may cause an UL communication with one or more of the access points within communications range, such as by the processing circuitry 22, processor 24, communications interface 26 or like. For example, the fixed mobile terminal may be configured to communicate with access points 12a-c in any available UL sub frame. In some example embodiments, the fixed mobile terminal 10 may utilize predefined scheduling to access a particular UL subframe.

In further example embodiments and as shown with respect to FIG. 1, the fixed mobile terminal 10 may be located at an intersection point of a number of access points, such as access points 12a-c. The example fixed mobile terminal 10 may be configured to report its capability to the one or more access points 12a-c. Once the capabilities (e.g. mobile terminal is a fixed mobile terminal) are known by one or more access points 12a-c, then the access points may schedule the fixed mobile terminal 10 to send/receive information between the access points 12a-c. Alternatively or additionally, the fixed mobile terminal 10 may be deployed by an operator and in such a case; the fixed mobile terminal 10 may not transmit a capability report. See for example FIG. 1. Further the fixed mobile terminal 10 may not deed to perform a Non-Access-Stratum (NAS) procedure, for example attachment, location registration and/or the like because the information that is used for the transmission and reception of IC messages, may in some example embodiments, be radio access network (RAN) related.

In one example implementation and with reference to FIG. 1, an example fixed mobile terminal 10 may be deployed at an intersection of access point 12a; access point 12b and/or access point 12c. Upon S1 connection establishment, an example core network may cause the fixed mobile terminal's 10 capabilities to be transmitted to access point 12a, access point 12b and access point 12c. Alternatively or additionally, in an instance in which access points 12a-cdo not receive capability information from the core network (e.g. due to the mobile terminal being in Evolved Packet System (EPS) mobility management (EMM)-DEREGISTERED), the access points 12a-c may request the fixed mobile terminal 10 to provide its capabilities using a mobile terminal capability transfer procedure. In some example embodiments, the fixed mobile terminal 10 may cause its capabilities to be transmitted without a communication from the core network.

After determining the capabilities of the fixed mobile terminal 10, access point 12a may be configured to schedule the fixed mobile terminal 10 and may be further configured to transmit an IC message to the fixed mobile terminal 10. The IC message may then be transmitted to neighbor access point 12b and access point 12c at for example, subframe 1, 4, 7 . . . as is shown with reference to access point 12a in FIG. 5. In an instance in which the IC message is received from access point 12a, the fixed mobile terminal 10 may cause an SR to be transmitted to access point 12b and access point 12c. In response, access point 12b and access point 12c may start to schedule the fixed mobile terminal 10 with a higher priority than other mobile terminals (e.g. a device used by an end-user to communicate or transfer data over the network) after receiving the SR from the fixed mobile terminal 10. In an instance in which the fixed mobile terminal 10 receives the uplink grant, the fixed mobile terminal 10 may transmit IC message to access point 12b and/or access point 12c.

In another example, after determining the capabilities of the fixed mobile terminal 10, access point 12b may be configured to schedule the fixed mobile terminal 10 and may be further configured to transmit an IC message to the fixed mobile terminal 10. The IC message may then be transmitted to neighbor access point 12a and access point 12c at for example, subframe 2, 5, 8 . . . as is shown with reference to access point 12b in FIG. 5. In an instance in which the IC message is received from access point 12b, fixed mobile terminal 10 starts to send SR to access point 12a and access point 12c, and the order is up to mobile terminal 10's implementation. In response, access point 12a and access point 12c may start to schedule the fixed mobile terminal 10 with higher priority than other mobile terminals (e.g. a device used by an end-user to communicate or transfer data over the network) after receiving SR from the fixed mobile terminal 10. In an instance in which the fixed mobile terminal 10 receives the uplink grant, the fixed mobile terminal 10 may transmit IC message to access point 12a and/or access point 12c.

In yet another example, after determining the capabilities of the fixed mobile terminal 10, access point 12c may be configured to schedule the fixed mobile terminal 10 and may be further configured to transmit an IC message to the fixed mobile terminal 10. The IC message may then be transmitted to neighbor access point 12a and access point 12b at for example, subframe 3, 6, 9 . . . as is shown with reference to access point 12a in FIG. 5. In an instance in which the IC message is received from access point 12c, fixed mobile terminal 10 starts to send SR to access point 12a and access point 12b, and the order is up to mobile terminal 10′s implementation. In response, access point 12a and access point 12b may start to schedule the fixed mobile terminal 10 with higher priority than other mobile terminals (e.g. a device used by an end-user to communicate or transfer data over the network) after receiving SR from the fixed mobile terminal 10. In an instance in which the fixed mobile terminal 10 receives the uplink grant, the fixed mobile terminal 10 may transmit IC message to access point 12a and/or access point 12b.

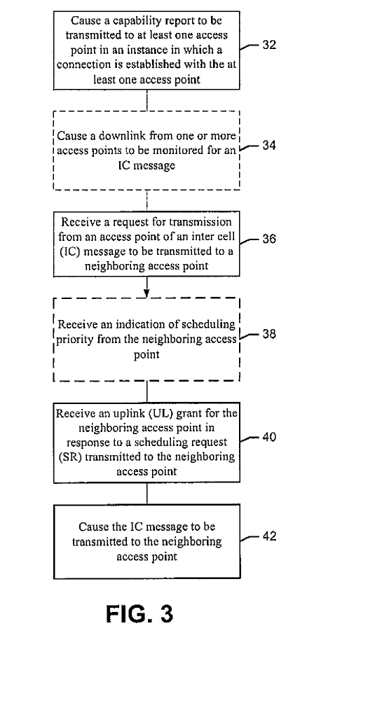

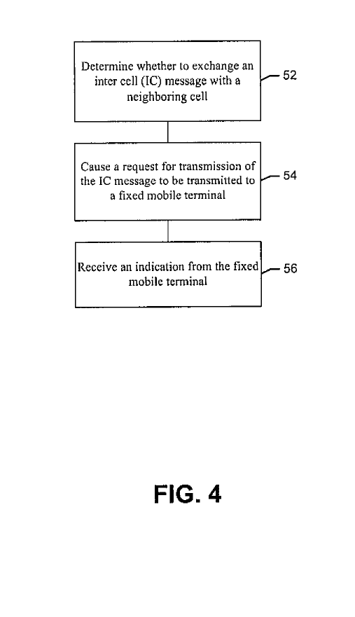

FIGS. 3 and 4 are example flowchart illustrating the operations performed by a method, apparatus and computer program product, such as apparatus 20 of FIG. 2 in accordance with one embodiment of the present invention is illustrated. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 28 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 3 and 4, when executed, convert a computer or processing circuitry into a particular machine configured to perform an example embodiment of the present invention. Accordingly, the operations of FIGS. 3 and 4 define an algorithm for configuring a computer or processing circuitry 22, e.g., processor, to perform an example embodiment. In some cases, a general purpose computer may be provided with an instance of the processor which performs the algorithm of FIGS. 3 and 4 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included (an example of which is shown in dashed lines in FIG. 3). It should be appreciated that each of the modifications, optional additions or amplifications below may be included with the operations above either alone or in combination with any others among the features described herein.

Referring now to FIG. 3, the operations of a method, apparatus and computer program product are configured to perform OTAC communications between multiple access points. As shown in operation 32, the apparatus 20 that is embodied, for example, by the fixed mobile terminal 10 may include means, such as the processing circuitry 22, the processor 24, the communications interface 26 or the like, for causing a capability report to be transmitted to at least one access point in an instance in which a connection is established with the at least one access point. The capability report may include an identification of the fixed mobile terminal. As shown in operation 34, the apparatus 20 that is embodied, for example, by the fixed mobile terminal 10 may include means, such as the processing circuitry 22, the processor 24, the communications interface 26 or the like, for causing a downlink from one or more access points to be monitored for an IC message. In some example embodiments the downlink from the one or more access points is monitored using TDM, while in other example embodiments, a downlink instant of the one or more access points may be known and/or discovered by the fixed mobile terminal in an instance in which the fixed mobile terminal is operating in a TDD network.

As shown in operation 36, the apparatus 20 that is embodied, for example, by the fixed mobile terminal 10 may include means, such as the processing circuitry 22, the processor 24, the communications interface 26 or the like, for receiving a request for transmission from an access point of an IC message to be transmitted to a neighboring access point. Upon receipt of an IC message request, the example fixed mobile terminal 10 may be configured to cause an ST message to be transmitted to one or more connected access points. As shown in operation 38, the apparatus 20 that is embodied, for example, by the fixed mobile terminal 10 may include means, such as the processing circuitry 22, the processor 24, the communications interface 26 or the like, for receiving an indication of scheduling priority from the neighboring access point.

As shown in operation 40, the apparatus 20 that is embodied, for example, by the fixed mobile terminal 10 may include means, such as the processing circuitry 22, the processor 24, the communications interface 26 or the like, for receiving an UL grant for the neighboring access point in response to a SR to be transmitted to neighboring access point. As shown in operation 42, the apparatus 20 that is embodied, for example, by the fixed mobile terminal 10 may include means, such as the processing circuitry 22, the processor 24, the communications interface 26 or the like, for causing the IC message to be transmitted to the neighboring access point.

Referring now to FIG. 4, the operations of a method, apparatus and computer program product are configured to perform OTAC communications between multiple access points. As shown in operation 52, the apparatus 20 that is embodied, for example, by the access points 12a-c may include means, such as the processing circuitry 22, the processor 24, the communications interface 26 or the like, for determining whether to exchange an IC message with a neighboring cell. An access point, such as access points 12a-c, may exchange an OTAC message with another access point in an instance in which an access point within communications range is not configured with an X2 interface.

As shown in operation 54, the apparatus 20 that is embodied, for example, by the access points 12a-c may include means, such as the processing circuitry 22, the processor 24, the communications interface 26 or the like, for causing a request for transmission of the IC message to be transmitted to a fixed mobile terminal. In some example embodiments, the request for transmission comprises scheduling information for the fixed mobile terminal. The example access points 12a-c may schedule the fixed mobile terminal 10 in its pre-defined subframes. As shown in operation 54, the apparatus 20 that is embodied, for example, by the access points 12a-c may include means, such as the processing circuitry 22, the processor 24, the communications interface 26 or the like, for receiving an indication from the fixed mobile terminal. In some example embodiments, the indication provides a confirmation that the IC message was transmitted to the another access point in an instance in which the fixed mobile terminal received receiving an UL grant for the another access point.

Advantageously, for example, the systems and methods as described herein may be configured to, for example reduce the transmission delay among neighbor access points. Further, as described herein the example fixed mobile terminal may operate without an assigned UL/DL pair, which aids to ease of use and further includes no limitation on power.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving, from an access point, a request for transmission of an inter cell (IC) message that is to be transmitted to a neighboring access point, wherein the request for transmission further comprises scheduling information from the access point;
receiving an indication of scheduling priority from the neighboring access point;
receiving an uplink (UL) grant for the neighboring access point in response to a scheduling request (SR) transmitted to the neighboring access point; and
causing the IC message to be transmitted to the neighboring access point.

2. The method according to claim 1, further comprising causing a capability report to be transmitted to at least one access point in an instance in which a connection is established with the at least one access point, wherein the capability report includes an identification of a fixed mobile terminal.

3. The method according to claim 1, further comprising causing a downlink from one or more access points to be monitored for an IC message.

4. The method according to claim 1, further comprising causing an SR to be transmitted to one or more access points, in an instance in which an IC message is received.

5. The method according to claim 3, wherein the downlink from the one or more access points is monitored using time division multiplexing (TDM).

6. The method according to claim 3, wherein a downlink instant of the one or more access points is known by the fixed mobile terminal in an instance in which the fixed mobile terminal is operating in a time division duplexing (TDD) network.

7. An apparatus comprising:
at least one processor; and
at least one memory including computer program code, the at least one memory and the computer program code configured to, with the at least one processor, cause the apparatus to at least:
receive, from an access point, a request for transmission of an inter cell (IC) message that is to be transmitted to a neighboring access point, wherein the request for transmission further comprises scheduling information from the access point;
receive an indication of scheduling priority from the neighboring access point;
receive an uplink (UL) grant for the neighboring access point in response to a scheduling request (SR) transmitted to the neighboring access point; and
cause the IC message to be transmitted to the neighboring access point.

8. The apparatus according to claim 7, wherein the at least one memory including the computer program code is further configured to, with the at least one processor, cause the apparatus to cause a capability report to be transmitted to at least one access point in an instance in which a connection is established with the at least one access point, wherein the capability report includes an identification of a fixed mobile terminal.

9. The apparatus according to claim 7, wherein the at least one memory including the computer program code is further configured to, with the at least one processor, cause the apparatus to cause a downlink from one or more access points to be monitored for an IC message.

10. The apparatus according to claim 7, wherein the at least one memory including the computer program code is further configured to, with the at least one processor, cause the apparatus to cause an SR to be transmitted to one or more access points, in an instance in which an IC message is received.

11. The apparatus according to claim 9, wherein the downlink from the one or more access points is monitored using time division multiplexing (TDM).

12. The apparatus according to claim 9, wherein a downlink instant of the one or more access points is known by the fixed mobile terminal in an instance in which the fixed mobile terminal is operating in a time division duplexing (TDD) network.

13-24. (canceled)

25. A method comprising:
determining whether to exchange an inter cell (IC) message with a neighboring cell;
causing a request for transmission of the IC message to be transmitted to a fixed mobile terminal, wherein the request for transmission comprises scheduling information for the fixed mobile terminal; and
receiving an indication from the fixed mobile terminal, wherein the indication provides a confirmation that the IC message was transmitted to the neighboring cell in an instance in which the fixed mobile terminal received an uplink (UL) grant for the another access point.

26. The method according to claim 25, further comprising causing the fixed mobile terminal to be scheduled in a predefined communications sub-frame.

27. The method according to claim 25, further comprising causing the fixed mobile terminal to be granted with a higher scheduling priority in an instance in which a SR is received from the fixed mobile terminal.

28. The method according to claim 25, further comprising receiving a capability report from the fixed mobile terminal, wherein the capability report includes an identification of a fixed mobile terminal.

29-40. (canceled)

41. The method according to claim 2, wherein the capability report is transmitted based on states of Evolved Packet System (EPS) Mobility Management (EMM) of the fixed mobile terminal.

42. The apparatus according to claim 8, wherein the capability report is transmitted based on states of Evolved Packet System (EPS) Mobility Management (EMM) of the fixed mobile terminal.

43. The method according to claim 28, wherein the capability report is transmitted based on states of Evolved Packet System (EPS) Mobility Management (EMM) of the fixed mobile terminal.

44. The method according to claim 1, wherein the IC message has a structure including plural subframes, each associated with each of available access points.
